(19) United States
(12) Patent Application Publication
(10) Pub. No.: US 2016/0243570 A1
(43) Pub. Date: Aug. 25, 2016

(54) Electric tank dispenser having a pressurizable space and selectable pressure levels

(71) Applicants: John Karl Lampe, St. Paul, MN (US); Jason Lee Wahlstrom, Ogilvie, MN (US)

(72) Inventors: John Karl Lampe, St. Paul, MN (US); Jason Lee Wahlstrom, Ogilvie, MN (US)

(73) Assignee: Green Shoots, LLC, St. Paul, MN (US)

(21) Appl. No.: 15/018,013

(22) Filed: Feb. 8, 2016

Related U.S. Application Data
(60) Provisional application No. 62/262,814, filed on Dec. 3, 2015.
(60) Provisional application No. 62/240,323, filed on Oct. 12, 2015.
(60) Provisional application No. 62/115,684, filed on Feb. 13, 2015.

(51) Int. Cl. B05B 12/08; B05B 15/06; B05B 1/30; B05B 7/24

(52) U.S. Cl. CPC B05B 12/087; B05B 7/2491; B05B 15/061; B05B 1/30

(57) ABSTRACT

This invention relates to a device for dispensing spray drops or foam. A first illustrative example of the invention is an electrically powered dispenser comprising: a pressurization system for automatically regulating a pressure level of a gas in a pressurizable space, the pressurization system being configured: to take a pressure reading of the gas, to make a determination if the pressure reading indicates a deviation from a desired pressure level, and based on the determination to make a decision selected from a list comprising at least the following: to start pressurization, to continue pressurization, to stop pressurization, or to do nothing. According to variations or refinements of this first example the pressurization system is sufficiently sensitive to indicate the deviation even if the deviation is minimal. According to other variations or refinements of this first example, the desired pressure level can be, e.g., less than 10 psi.

### CROSS-REFERENCE TO RELATE APPLICATIONS

This application claims the benefit of U.S. Provisional applications: No. 62/115,684, filed Feb. 13, 2015; No. 62/240,323, filed Oct. 12, 2015; and No. 62/262,814, filed Dec. 3, 2015. This invention relates to a device for dispensing either spray drops or foam.

### BACKGROUND OF THE INVENTION

The prior art contains many dispensers that dispense liquid drops or foams or both. For many uses, liquid drop sprayers can be useful. Drop spray technology can handle a wide variety of materials including liquid solutions, colloids, suspensions, and emulsions. Solutions can have water or oils of varying grades as the solvent. This makes drop sprayers very versatile.

Different spray nozzles can emit drops that form well-defined patterns. Those patterns can include, for example, a solid stream, fan-shape, cone, hollow cone, multiple plume. Conventional spray nozzles can come in different spray angles, typically ranging from 15 to 150 degrees of “theoretical coverage.” Drop sizes can also be controlled fairly well, at least at the point where they exit the nozzle. Sizes can range from extremely fine (less than 60 microns) to ultra coarse (greater than 650 microns). Air can be introduced into the nozzle with air induction to change the nature of the drops.

For dispensing, conventional sprayers can have disadvantages. One big disadvantage of a spray is that much of the dispensed fluid may not reach the target. This may happen for a number of reasons. Many conventional systems operate under high pressure. High pressure can create more fine drops. The finest drops of some liquids may vaporize during dispensing. Vapors will not likely reach a target because the operator of the sprayer cannot control their path. Vapors can move hundreds of meters off-site under certain conditions outdoors. This can lead to harm to beneficial plants and pose risks to humans and animals. Indoors, vapors can remain suspended for long periods of time. This can cause problems such as health concerns for humans and animals.

Even slightly larger fine drops can move meters in a relatively light wind or current outdoors. Drops dispensed indoors from conventional sprayers may be less susceptible to airborne movement. However, because of the confined space, people, animals, and plants in the vicinity may risk greater exposure from off-target movement. This exposure may have negative effects.

If spray drops do reach the target, not all of them will be effective. The smaller drops on a surface can dry quickly, especially in open sun or on warm surfaces. One example is cleaners sprayed on a non-absorbent surface such as a window, a smooth countertop, or a motor vehicle's body. If drops dry too quickly, the advantages of having that cleaner in liquid form is then largely lost. Re-wetting may be necessary. Streaking or even abrasion can result from use of a rag or other wiping implement. Undesirable residues of cleaner may be left on the surface.

Spray patterns from conventional sprayers can also be very uneven—coarse drops are often at the center and finer drops at the periphery of the spray pattern. This is especially noticeable when treating or cleaning absorbent materials such as fabric. The fine drops may dry quickly on the surface of the fabric, thereby becoming largely ineffective; the coarse drops may soak in. This inconsistency can require repeated spraying. Oftentimes, what results are patches of soaked and dry fabric.

Then, there are drops that reach the target and then leave. Large drops may contact the target surface and bounce, roll, or drip off. Drops moving at higher velocities may bounce or splatter. Even when conditions may seem right, a spray under moderate pressure and a target that is relatively absorbent—a large drop can move before it has time to start soaking.

Still another problem with fine sprays from conventional sprayers is that they can often be very hard to see—either when being dispensed or when they are on a surface. Thus, a person may not realize how much of the spray is volatilizing or moving off-target. Even on the target surface, it can be difficult to notice where there is over-coverage or under-coverage.

In short, there are numerous ways a dispensed drop from a conventional sprayer can miss its target. Moreover, even when that drop hits the target, the drop may be in an ineffective form—too dry; too fine; too heavy, etc. If this happens, economic, health, and environmental harm can result.

One way to solve many of the problems associated with conventional sprayers is to improve the quality of the spray. There can be several solutions: A first is dispensing drops that are not so fine. The slightly larger drops will be less likely to drift or quickly dry on the target surface. A second is dispensing drops at lower velocity. Lower velocity can reduce the likelihood that drops will break apart into small drops during delivery. Lower velocity also lessens the chance that drops will bounce off a target surface. A third is dispensing drops that are consistently sized. Drops of a consistent size can allow the spray operator to make consistent adjustments. For example, If finer drops are being produced but they are a consistent size, the spray nozzle can be brought closer to the target surface to minimize volatilization.

Foams can also help solve many of the problems associated with off-site movement, overspray, and coverage inconsistencies associated with dispensed chemicals. First, foams can evaporate and dry slower than liquids. This can be the case both in transit from the dispenser to the target and when the foam reaches the target. This has advantages both in reducing vaporization but also in keeping the active ingredients moist so they can do their work.

Second, foams can be a highly precise way to make an application. Foams can be highly effective when they are wiped or dabbed onto a surface. This can allow for very precise applications to very small targets. Third, a foam can be easily applied and then spread on a surface with a wiping implement such as a mop or rag, for example. Fourth, foams can cling tenaciously to surfaces, even to vertical and very slippery ones.

Fifth, foam can absorb shocks or blows very well in comparisons to liquids. This means that foam can be projected at a surface and not as easily bounce off it as spray drops. Thus, when foam hits a surface even at fairly high pressure, the foam tends to stay in place and even help cushion incoming foam. Sixth, foams can act as insulators and barriers—this is especially important in activities such as firefighting.

Seventh, foams remain highly visible, both when streaming from a nozzle and when adhering to an object. This makes it easier for the operator to observe over-coverage or under-coverage. Eighth, the characteristics of foams can be adjusted—from very wet foams to drier foams. This makes them highly flexible. A wetter foam has more weight and can generally be projected greater distances; it can hold more active ingredient. Dry foams are extremely light and can maintain their foam structure for long periods of time and can provide greater insulation. For these and many other reasons as discussed below, foams can be very useful.

The purpose of the present invention is to overcome limitations of prior art dispensing systems.

### BRIEF SUMMARY OF THE INVENTION

This invention relates to a device for dispensing spray drops or foam. In one example, the dispenser can be powered with a battery and dispense at low pressure. The figures and descriptions that follow help describe aspects of the invention.

A first illustrative example of the invention is an electrically powered dispenser comprising: a pressurization system for automatically regulating a pressure level of a gas in a pressurizable space, the pressurization system being configured: to take a pressure reading of the gas, to make a determination if the pressure reading indicates a deviation from a desired pressure level, and based on the determination to make a decision selected from a list comprising at least the following: to start pressurization, to continue pressurization, to stop pressurization, or to do nothing.

In this first example, the decision to start pressurization is made if the pressure reading indicates the deviation, the deviation is below the desired pressure level, and pressurization is not ongoing; the decision to continue pressurization is made if the pressure reading indicates the deviation, the deviation is below the desired pressure level, and pressurization is ongoing; the decision to stop pressurization is made if the pressure reading does not indicate the deviation and pressurization is ongoing; and the decision to do nothing is made if the pressure reading does not indicate the deviation and pressurization is not ongoing.

According to variations or refinements to this first example, the list could be configured to have additional items: For example: the list can further comprise the decision to increase the rate of pressurization if the determination is that the pressure reading is below the desired pressure level and the deviation is significant.

The list can further comprise the decision to increase the rate of pressurization if the determination is that the pressure reading is below the desired pressure level and the deviation is significant. Significance of the deviation can depend on the size of the tank. For most human-carried systems, a deviation of 2 or 4 psi or greater can be considered significant. For larger ones, a deviation of more than 4 psi can be considered significant.

According to variations or refinements of this first example the pressurization system is sufficiently sensitive to indicate the deviation even if the deviation is minimal. Minimal can be, for example, between 0.1 and 1.0 psi; between 0.1 and 0.5 psi; or between 0.1 and 0.3 psi. Although not preferable, the pressurization system could be configured to sense only moderate deviations, for example, ones greater than 1.0 psi.

According to other variations or refinements of this first example, the desired pressure level can be, e.g., less than 40 psi; less than 30 psi; less than 20 psi; less than 15 psi; less than 10 psi; less than 8 psi; less than 5 psi; or less than 2.5 psi. Based on current nozzle tip technology, it is preferable for many uses to have the desired pressure level set lower than 15 psi or even 10 psi, in order to avoid excessive drift and off-target spray.

According to other variation or refinements of this first example, the desired pressure level is selectable, for example, by an operator. It can be selectable from at least 2 selectable pressure levels. It can also be selectable from at least 5, 10, 15, 20, or more pressure levels. The desired pressure is selectable, for example, by an operator using a manual adjustment mechanism. If the pressure level is selectable, It is also preferable to have a range of selectable pressure levels: e.g., selectable from at least 2 selectable pressure levels with at least one of those selectable pressure levels being less than 20 psi; less than 15 psi; less than 10 psi; less than 8 psi; or less than 5 psi.

According to other variations or refinements of this first example, one of the decisions that can be included in the list of decisions made by the pressurization system is to depressurize the pressurizable space. This decision is made if the pressure reading indicates the deviation, and the deviation is above the desired pressure level. Another decision included in the list can be the decision to depressurize if the electric dispenser system is turned off or if the electric dispenser has not operated for a specified period of time, such as 2, 4, 6, or 10 minutes.

According to other variations or refinements of this first example, another decision that can be included in the list of decisions made by the pressurization system is to increase the rate of pressurization. This decision is made if the pressure reading is below the desired pressure level, and the deviation is significant. Significant deviation can be, e.g., a deviation of 2 psi or greater; a deviation of 3 psi or great; or a deviation of 4 psi or greater.

According to other variations or refinements of this first example, the dispenser further comprises an outlet assembly for ejecting spray drops or the dispenser further comprises an outlet assembly for ejecting foam.

According other variations or refinements of this first example, the dispenser further comprises a supply tank further comprising a headspace, wherein the headspace forms at least a part of the pressurizable space. In other variations, a sampling tube forms or an air supply tube forms at least a part of the pressurizable space.

A second illustrative example of the invention is an electrically powered dispenser, comprising: a pressurization system for automatically regulating pressure in a pressurizable space, the pressurization system being configured to regulate pressure in the pressurizable space to achieve a desired a pressure level wherein the desired pressure level is 10 psi or less.

According to variations or refinements of this second example, the desired pressure level can be, e.g., 8 psi or less; 7 psi or less, 5 psi or less; or 2.5 psi or less.

A third illustrative example of the invention is an electrically powered dispenser, comprising: a supply tank, the supply tank further comprising a top with an opening for filling the supply tank; a reusable closure for sealing the opening; and a pressurizable space created when the reusable closure seals the opening; wherein the closure contains a pressurization system for automatically regulating a pressure level to seek a desired pressure level in the pressurizable space.

According to variations or refinements of this third example, the closure is an external closure on the supply tank; the external closure is a cap with a belly hanging within an interior of the cap, a skirt having a lower rim, wherein the belly is recessed within the interior in comparison to at least a portion of the lower rim.

According to variations or refinements of this third example: wherein the closure is an internal closure on the supply tank; wherein the structure of the closure is cylindrical and, when forming a seal on the supply tank, the closure shares a vertical axis with a cylindrically shaped supply tank.

A fourth illustrative example of the invention is an electrically powered dispenser, comprising: a pressurization system for automatically regulating pressure in a pressurizable space at a desired a pressure level wherein at least a portion of the pressurization system is located remotely from the supply tank.

According to variations or refinements of this fourth example: the remote portion of the pressurization system is an air pump. The air pump can be connected to the supply tank with an air supply tube. In another variation the remote portion is a sensing system. The sensing system can be connected to the supply tank with a sampling tube. The remote portion can be a control panel. The control panel can be electronically linked to a pump head mounted on the supply tank.

According to variations or refinements of this fourth example, the remote portion of the pressurization system is located remotely from the supply in a first and second remote location, wherein the pump head is located remotely from the supply tank in a first remote location and a control panel is located remotely from the supply tank in a second remote location.

The examples, variations, and refinements mentioned above can be combined in ways other than those stated. Other examples, variations, and refinements are explained below.

### BRIEF DESCRIPTION OF THE SEVERAL VIEWS OF THE DRAWINGS

FIG. 1A is a side view of an electrically powered pressurized tank dispenser.

FIG. 1B is a side view of the outlet assembly.

FIG. 2A is a side view of an electric pressurized tank dispenser with a wand.

FIG. 2B is a diagram showing three systems: a pressurization system; a pressurized fluid storage system; and an output system.

FIG. 2C is a schematic of an electrical system for the dispenser.

FIG. 2D is a side view of a pump head for the dispenser.

FIG. 2E is a top view of a pump head for the dispenser.

FIG. 2F is a side view of internal components of a pressurization system for the dispenser.

FIG. 2G is a side view of an outlet assembly.

FIG. 3A is a side view of an electrically powered pressurized tank dispenser with a conventional dip tube and nozzle.

FIG. 3B is a side view of an electrically powered pressurized tank dispenser for spraying liquid drops with a shoulder strap.

FIG. 4A is a side view of an electrically powered pressurized tank dispenser mounted in a backpack frame.

FIG. 4B is a front view of an electrically powered pressurized tank dispenser mounted in a backpack frame.

FIG. 5A is a side view of an electrically powered pressurized tank dispenser mounted on a cart.

FIG. 6A is an internal view of the components of the pump head for an electrically powered pressurized tank dispenser.

FIG. 6B is a top view of the pump head of an electrically powered pressurized tank dispenser.

FIG. 7A is a side view of an electrically powered pressurized tank dispenser with a wand with threads the supply tank shown in dashed line.

FIG. 7B is a side, sectional view of the housing of the pump head and the cover.

FIG. 8A is a side view of a vehicle with an electrically powered pressurized tank dispenser mounted on it.

### DETAILED DESCRIPTION

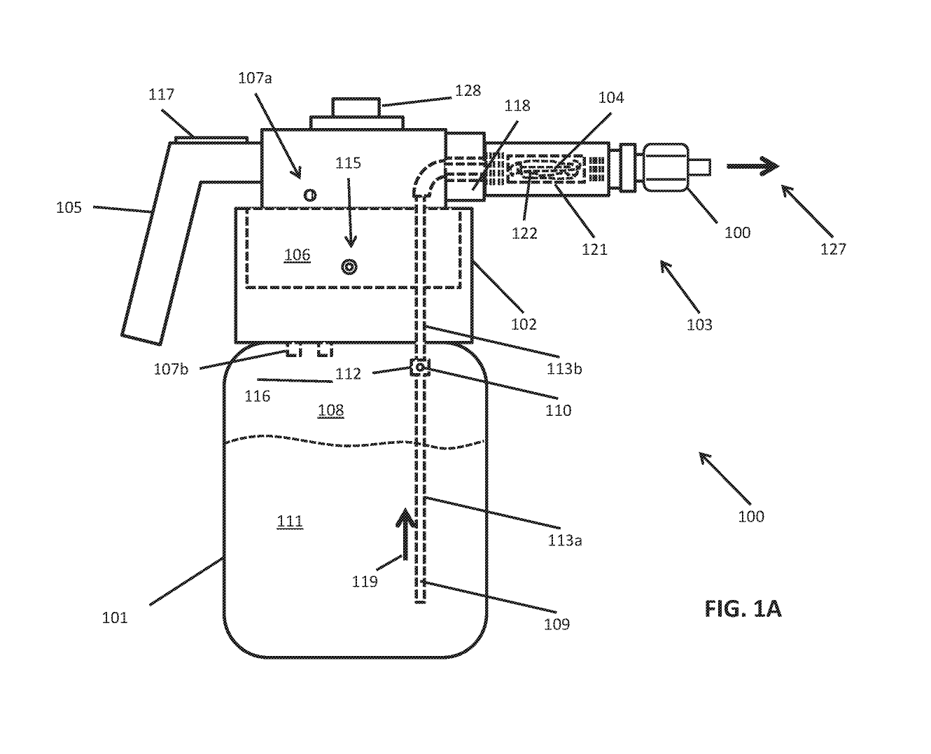

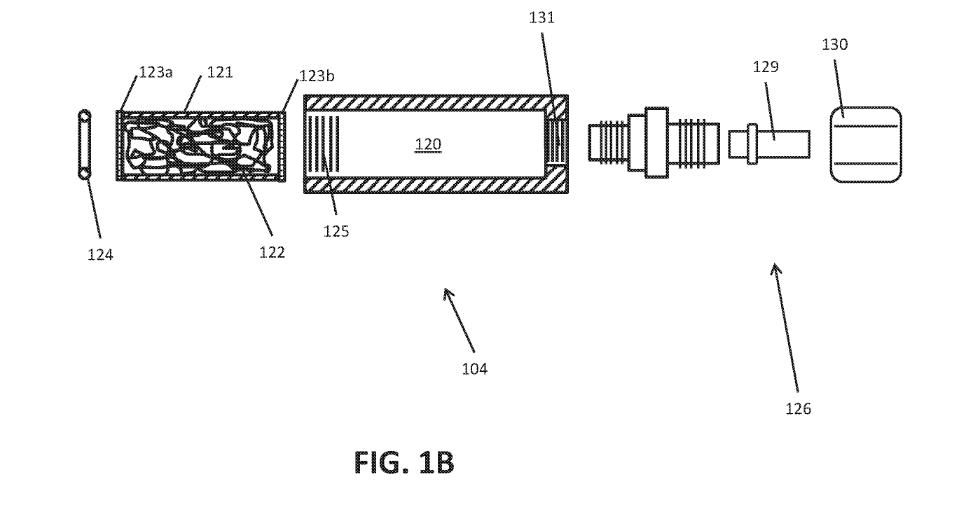

FIGS. 1A and 1B show an electrically powered pressurized tank fluid dispenser 100. The dispenser 100 can be especially suited to dispensing foam. The dispenser 100 might typically be carried in the hand by an operator and used for dispensing fluids for cleaning, treating, coating, etc.

The dispenser can include a supply tank 101, a pump head 102, and an outlet assembly 103. The supply tank 101 can be of varying sizes. For many uses, a handheld dispenser 100 such as the one shown can contain about 250 ml to 3 liters. The tank 101 can be filled by unscrewing the pump head and filling the tank with a liquid 111 such as a solution.

The pump head 102 can include a pressurization system 106 to pressurize the tank 101. The pressurization system 106 can have a control unit, a power source, a motor, and a pressurizer. (Most of the components of the pressurization system are not separately shown.) The control unit can control the pressurization system 106 and incorporate sensing units such as a pressure sensor 116.

The power source is preferably a portable one such as a battery cell. The battery can be rechargeable. FIG. 1A shows a port 115 for a charging connector. The motor can drive the pressurizer. The pressurizer can be an air pump. FIG. 1A shows an inlet for the pressurizer 107a for drawing in ambient air and an outlet 107b for introducing pressurized air into the supply tank 101, preferably into the headspace 108.

The outlet assembly 103 in this example can be affixed to the pump head 102. The outlet assembly 103 can include a mixing chamber 104 for creating or conditioning a foam fluid and a nozzle 126. Opposite the outlet assembly 103 is a handle 105 for holding the dispenser 100.

The dip tube 109 of the present invention can be a tube of a pliable material such as polyethylene with a vent 110. The vent 110 in this example is a hole made in a splicer 112 which connects two sections 113a, 113b of the dip tube 109. In operation, as liquid 111 under headspace 108 pressurization is forced into the dip tube 109, the vent 110 can introduce a quantity of that air from the headspace 108 into the fluid stream 119. The vent 110 can preferably be positioned so it can remain above the liquid 111, i.e., in the headspace 108, during dispenser 100 operation in order to prevent the liquid 111 in the supply tank 101 from blocking the entry of headspace 108 air into the vent 110.

The dip tube 109 and splicer 112 can have an inside diameter of approximately 2 to 10 mm depending on various factors such as pressure, the volume of liquid 111 desired to be dispensed, and the size of the dispenser 100.

For most hand carried dispensers such as this one, the vent 110 can be a very small opening into the splicer 112—e.g., the vent 110 can be a hole with a diameter between approximately 0.3 mm and 2 mm and more preferably between 0.6 mm and 1.5 mm and even more preferably between 0.7 mm and 1.3 mm.

The dispenser 100 can be activated with a switch such as an on-off button 117. Depressing the button 117 can do two things. First, it can activate the controller which can turn on the pressure sensor 116. If the sensor 116 detects that pressure in the system is too low, the controller can activate the motor to increase pressurization in the head space 108. Once pressure reaches a desired level, and assuming the operator still has the button 117 in the “on” position, the controller can open a check valve 118 causing liquid to be drawn into the dip tube 109 creating a fluid stream 119 flowing up the dip tube. As the fluid stream 119 passes through the splicer 112, air from the headspace 108 can be drawn through the vent 110 into the dip tube 109 and mixed with the liquid 119. This can create a fluid stream 119 with some bubbles (probably of varying sizes and quality). The fluid stream 119 can eventually pass through the check valve 118 and enter the mixing chamber 104.

The mixing chamber 104 can be attached to the pump head in various ways such as by a threaded connection 125. The mixing chamber 104 can have a tubular shape with a void 120 into which a cartridge 121 can be inserted as shown in FIGS. 1A and 1B. Preferably, the cartridge 121 can also be tubular and translucent or clear so that its contents can be viewed.

The cartridge 121 can contain a mixing media 122 such as stainless steel wool. The cartridge 121 can be from about 0.2 to 20 cm in length for many applications; and more preferably from about 1 to 10 cm; and still more preferably from about 2 to 7 cm. The diameter can be from about 0.2 to 5 cm for many uses and more preferably from 0.5 to 2. The cartridge 121 should preferably fit snugly in the void 120. Different cartridge dimensions and mixing media could be appropriate for dispensers of different sizes and kinds. Alternative or additional mixing media could be screens, steel wool, reticulated foams, and so forth.

A mesh screen 123a can enclose the proximate end and another mesh screen 123b the distal end of the cartridge 121. The screens 123a, 123b can be made of a variety of materials, e.g., wire cloth, plastic. A 304 Stainless Steel Wire Cloth Disc, 60×60 Mesh can be used for both the proximate and distal screens 123a, 123b.

The cartridge 121 can be held within the mixing chamber 104 by a retainer 124—in this instance the retainer 124 is an O-ring. The retainer 124 and cartridge 121 should fit to help ensure that excessive fluid 119 does not bypass treatment by the mixing media 122 inside the cartridge 121.

During operation, when the fluid stream reaches the mixing chamber 104, it can be conditioned by the mixing media 122. After conditioning in the mixing chamber 104, the foam fluid can travel through the nozzle 126 which can resemble a compression fitting. The nozzle 126 can include a tubular shaped orifice 129. The orifice can be approximately 0.1 to 2 cm in diameter and approximately 4 to 5 cm long.

The dispenser can function under very low pressures and still generate and dispense high quality foam. Table 1 shows pressure ranges that the dispenser could work at. These are ranked in order of preferability.

TABLE 1

| | Pressure - Low End | | Pressure - High End | |
|---|---|---|---|---|
| preferability | mbar | psi | mbar | psi |
| preferable | 7 | 0.1 | 2070 | 30 |
| more preferable | 14 | 0.2 | 1400 | 20 |
| still more preferable | 14 | 0.2 | 690 | 10 |
| most preferable | 14 | 0.2 | 670 | under 10 |

Operating the dispenser at the lower pressure range, e.g., under 670 mbar or under 10 psi can be most preferable for many reasons. These include: the lower pressure range can require less power. Components such as the power source and motor can be more compact and lighter. The tank, fittings, etc., can be less robust, and pressure can be maintained more easily in the supply tank. All of these can reduce design and production costs. Lower pressure can be also be safer for users because lower pressure reduces the potential for tank bursts, leakage, and misdirection of high energy chemical streams. Moreover, lower pressure can be useful for the operator in doing cleaning, treating, coating, and so forth.

The controller can incorporate an adjustment mechanism so that the pressurization level can be adjusted. For instance, an adjustment mechanism such as a dial 128 with settings could be turned to select a pressure level, ranging from 1 to 3. Selecting level “One” could have the controller stop the motor when the sensor 116 indicates 200 mbar (2.9 psi); level “Two” when the sensor 116 indicates 400 mbar (5.8 psi); and level “Three” when the sensor 116 indicates 600 mbar (8.7 psi). (In another embodiment, the on-off button could incorporate the adjustment mechanism—light finger force on the button could select level 1; more force level 2; and still greater force level 3.

Dispensing foam at level One, i.e., a maximum pressure of 200 mbar (2.9 psi) can be useful for dispensing relatively small amounts of foam or for dispensing with greater precision. Small, precise applications can be especially useful for treating small targets, e.g., cleaner to a small stain; herbicide to an isolated weed; ointment to a wound; soap or beauty care products to the hand or other parts of the body, and so forth. Such applications can virtually eliminate off-target movement of the applied foam material.

In addition to spot treatments, foam can be applied to large surfaces at this low setting. Because the dispenser is driven by a motor, a continuous stream of high quality foam could be dispensed for many minutes with limited volatilization. This could be useful for cleaning countertops, windows, etc.

The foam could be applied at close range—e.g., within a couple inches of a surface such as a countertop—or dispensed and allowed to fall onto the target surface for example dispensing foam cleaner on a floor. A sponge, a mop, other wiper could then be used to wipe the dispensed product on the surface.

Dispensing foam at level Two, i.e., a maximum pressure of 400 mbar (5.8 psi) can be useful for dispensing greater amounts of foam for spot treatments or for directing a foam stream at a surface. Level Two might be useful for directing a foam stream at a window at close range or to the fabric on a chair or sofa for cleaning or treating.

Dispensing foam at level Three, i.e., a maximum pressure of 600 mbar (8.7 psi) can be useful for directing a foam stream a greater distances. This setting could be used for applying foam soap at a vehicle or hitting a patch of weeds.

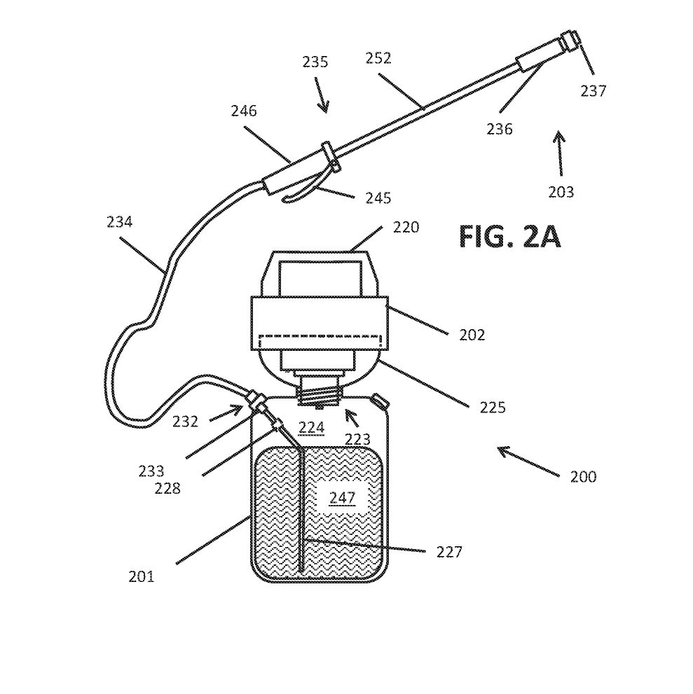

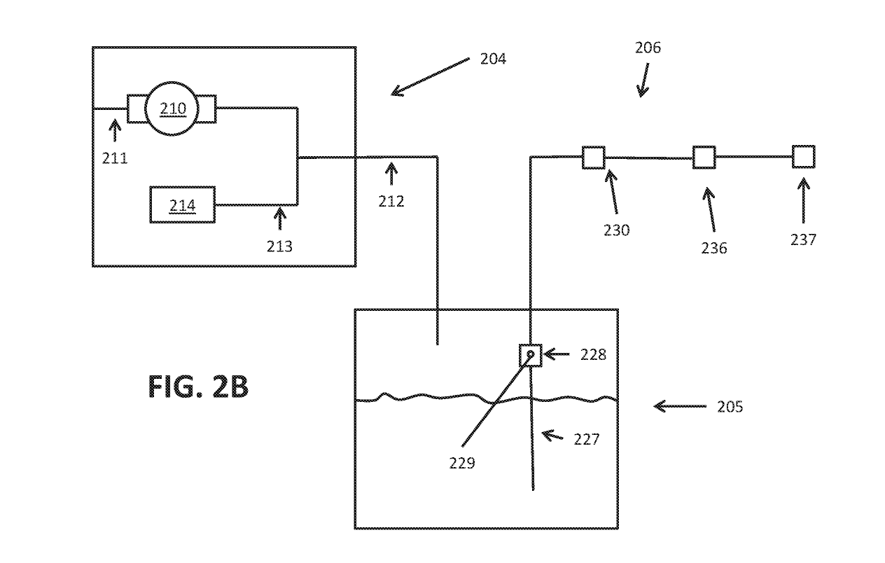

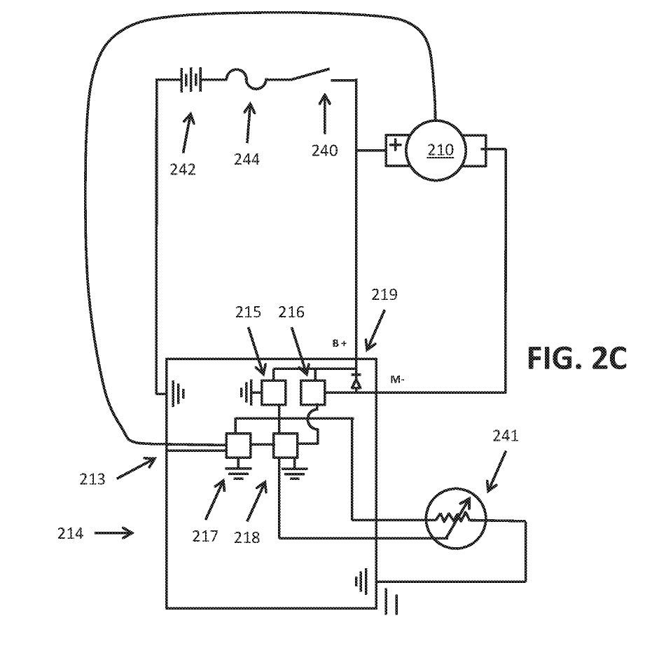

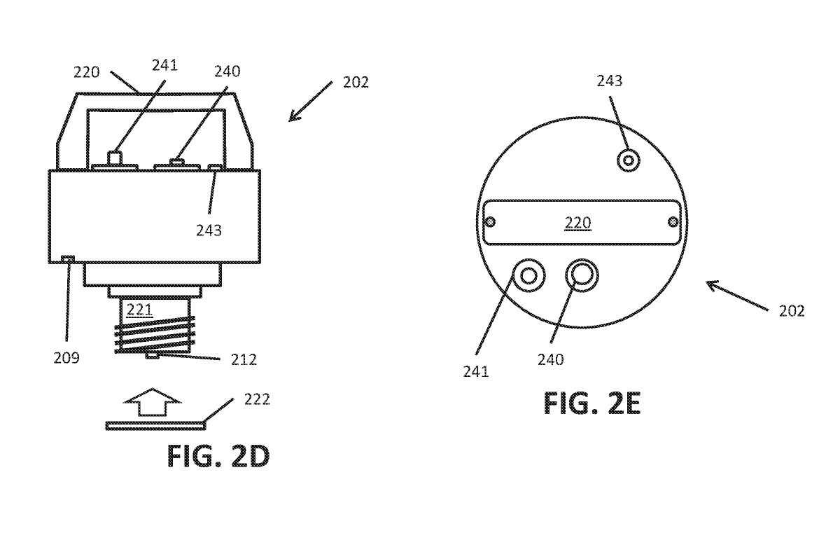

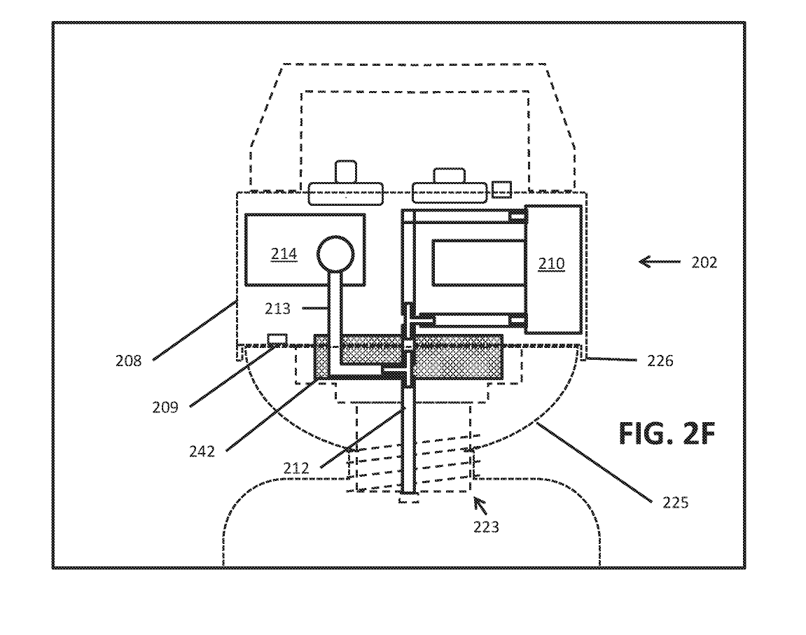

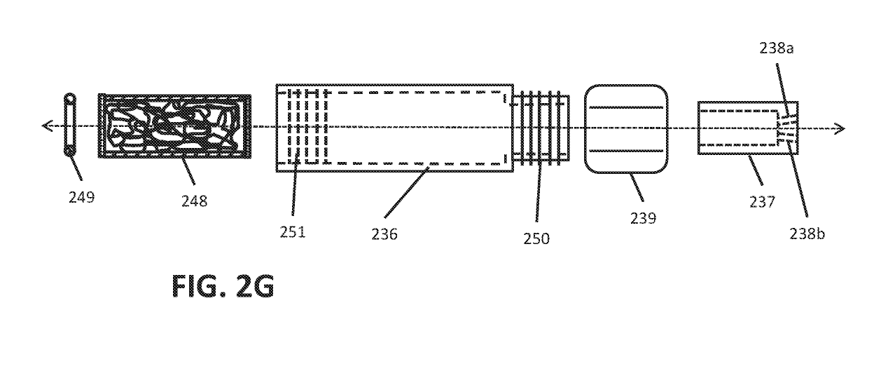

FIGS. 2A to 2G show an electrically powered pressurized tank dispenser 200. The dispenser 200 shown in FIG. 2A can resemble the example shown in FIGS. 1A and 1B. Like dispenser 100, dispenser 200 can have a supply tank 201, a pump head 202, and an outlet assembly 203. However, dispenser 200 can also have a hose 234 and wand 235. The tank 201 shown in FIG. 2A is also larger about 8 L or about 2.1 gallons and generally resembles the tank accompanying tank sprayer, Model #90162, Super Sprayer® available from H.D. Hudson Manufacturing Company of Chicago, Ill.

As shown in FIG. 2B, the dispenser 200 can be grouped into three systems: a pressurization system 204; a pressurized fluid storage system 205; and an output system 206. The pressurization system 204 can pressurize the fluid storage system 205. The output system 206 can withdraw the fluid from the storage system 205, condition it, and dispense the conditioned fluid, for instance, as a liquid spray or a foam.

The pressurization system 204 in this example has electronic components and can be located primarily in the pump head 202 as shown in FIG. 2F. The pump head housing 208 can enclose most of the pressurization system 204. The housing 208 can have an air inlet 209 (e.g., a hole in the wall of the housing 208) for entry of ambient air into the housing 208. The pressurization system 204 can include an air pump motor 210 with an air intake 211 (for drawing air from inside the housing 208 into the motor 210) connected to a pressurized air tube 212 for transferring pressurized air from the motor 210 to the supply tank 201; and a sampling tube 213 that branches off the pressurized air tube 212 and connects to a controller 214 for purposes of sampling the pressurized air in the tank 201. (The described connection of the pressurized air tube 212 and the sampling tube 213 to headspace 224 mean that those parts, like the headspace, can also be considered to be pressurized and part of a “pressurizable space” in the dispenser 200 that can be used to “push” a liquid or foam, for example, from the dispenser 200.

FIG. 2C shows the schematic for the electronic components of the pressurization system 204. The electronic components include: the air pump motor 210; the controller 214 including a voltage regulator 215, a MOSFET 216, a sensor (transducer) 217, a comparator 218, a diode 219; an on-off switch 240; an adjustment mechanism (potentiometer) 241; a battery 242; and a fuse 244. The battery 242 can be rechargeable with a charging port 243.

As with the pump head 102 shown in FIG. 1A, the pump head 202 can fit on the top of the tank 201. The pump head 202 can have a handle 220. The lower portion of the pump head 202 includes a threaded male plug 221 with a compressible washer or O-ring 222. The threaded male plug 221 can fit into a threaded hole 223 in the top part of the tank 201 and create an airtight seal. At the lower end of the plug 221 can be the distal end of the pressurized air tube 212 for introducing air created by the pressurization system 204 into the supply tank 201, preferably into the headspace 224. In this way, the pump head 202 can replace the manual pump (not shown) that accompanies a tank sprayer such as Model #90182.

Many tanks such as the one shown in FIG. 2A have a cup or shroud at the top, often referred to as a “funnel top.” The Hudson tank sprayer, Model #90182 has such a funnel top 225. The lower portion of the pump head housing 208 can fit down into the funnel top 225. This can have advantages. By fitting portions of the pump head housing 208 down into the funnel top 225, the weight of the pump head 202 can be lowered relative to the tank 201. Moreover, having the pump head 202 cover the funnel top 225 lessens the amount of debris that can collect in the funnel top 225. Having debris in the funnel top 225 can be inconvenient because it often has to be cleaned out before the tank 201 is refilled. To further limit the entry of debris into the funnel top 225, the housing 208 can have a lip 226 that overhangs the funnel top.

An additional advantage of this configuration of the pump head 202 and funnel top 225 has to do with the air inlet 209. As can be seen from FIGS. 2A and 2F, the air inlet 209 is located on the underside of the pump head 202 and is enclosed by portions of the pump head 202 and funnel top 225. This location can help protect the air inlet 209 from ingress of dust or debris. The housing lip 226 can further protect the inlet 209. However, in this example of the dispenser 200, the pump head 202 should preferably not fit too tightly onto the tank 201; otherwise, the flow of ambient air to the air inlet 209 could be restricted.

There is not a universally accepted system for connecting a pump head to a tank in prior art tank sprayers. Many tank sprayers, especially those with a funnel tops, have a threaded plug like Model #90182. However, others have a threaded cap that fits on a tank that resembles the tank 101 of the handheld tank sprayer 100 shown in FIG. 1A. The pump head 202 can be adapted to fit on different kinds of tanks used with tank sprayers.

In addition to the pressurization and storage systems, the dispenser 200 can have an output system 206 as depicted in FIG. 2B. The output system 206 can draw a pressurized fluid from the supply tank 201, condition it, and discharge it from the nozzle 237. The output system 206 can resemble aspects of the one shown in FIG. 1A. The output system 206 can include a dip tube 227, a splicer 228 with a vent 229, a check (or discharge) valve 230, and the outlet assembly 203.

The dip tube 227 in this example can be made of two pieces of tubing each with an ID of approximately 3 mm. Each can attach to the splicer 228. The splicer 228 can have an ID of approximately 2.3 mm. The splicer vent 229 can have an ID of about 0.9 mm.

The dip tube 227 can be connected to a tank fitting 232 attached to the wall of the tank 201. See FIG. 2A. A reducer 233 can be used to attach the dip tube 227 to the tank fitting 232 that accompanies Model #90182. The output system 206 continues with a hose 234 attached to a wand 235. The hose 234 and wand 235 available with Model #90182 can be suitable. The check valve 230 can be the same check valve 230 installed in the wand handle 246 of the wand 235 that accompanies Model #90182.

The outlet assembly 203 can generally be the same as the one shown in FIGS. 1A and 1B. It can have a mixing chamber 236 and nozzle 237 and dispense a foam. The nozzle 237 shown in FIG. 2G is slightly different from nozzle 126: it can have two orifices 238a, 238b, each with an ID of about 2 mm. The orifices 238a, 238b, shown can be slightly angled away from each other on the output (distal) end to help prevent the streams of foam from colliding. In addition, the nozzle 237 can be secured to a male threaded distal end 250 of the mixing chamber 236 with a flareless fitting 239. In constructing a prototype, the inventors used the following flareless fitting 239, Nut for ½ in. Tube OD Easy-Align Brass Compression Tube Fitting available from McMaster Carr, located in Illinois, U.S.A. As with mixing chamber 104 shown in FIG. 1B, mixing chamber 236 can have a cartridge 248 with mixing media held in place by a retainer O-ring 249. The threaded fitting 251 on the proximate end of the mixing chamber 236 can attach to the distal end of the wand tube 252.

An operator can deploy the dispenser 200 as follows: the on-off switch 240 can be switched on. This can activate the controller 214 which can turn on the pressure sensor 217. If the sensor 217 detects that pressure in the system is below a set pressure, the controller 214 can activate the motor 210 to increase pressurization in the head space 224 until the set pressure is reached. The set pressure is determined by the adjustment mechanism 241. In this example, the adjustment mechanism 241 can be a knob that allows “infinite adjustability”—turning the knob clockwise can increase the set pressure; turning the knob counterclockwise can decrease the set pressure.

Once the set pressure is reached, the controller 214 can turn the motor 210 off. Typically, when starting a job, the operator might set the pressure with the adjustment mechanism 241 and then turn the switch 240 on to allow the pump system to reach the set pressure. To discharge foam, from the outlet assembly 203, the operator can squeeze the lever 245 on the wand handle 246 to open the check valve 230. With the check valve 230 open, fluid 244 can be drawn into the dip tube 227 creating a fluid stream flowing up the dip tube 227. The fluid can be conditioned in the supply line and discharged as a foam out the nozzle 237.

The inventors built and tested a prototype dispenser configured generally like dispenser 200 shown in FIGS. 2A to 2G. In addition to parts from the Hudson tank sprayer, Model #90182, and other parts listed above, the inventors used: an air pump motor, Model #T.1C48G2.1C 48N2.B12V, from Parker Hannefin. The pressure sensor 217 was a transducer with a stated maximum of 14.5 psi from Freescale Semi Conductor, Mfg, Part #MPX5100GP, purchased from DigiKey.

To test the prototype, the inventors mixed a solution and added it to the tank of the prototype. The solution contained tap water and 0.08% by volume of Jarfactant™ 225DK, available from Jarchem Industries, Inc., of Newark, N.J. With the adjustment mechanism 241 turned to maximum power, the system could eject streams of foam that generally broke into an even spray pattern of foam clusters or globs with a distance of approximately 7 to 12 feet. With maximum power the tank could maintain a pressure of about 6 psi with the dispenser in continuous operation.

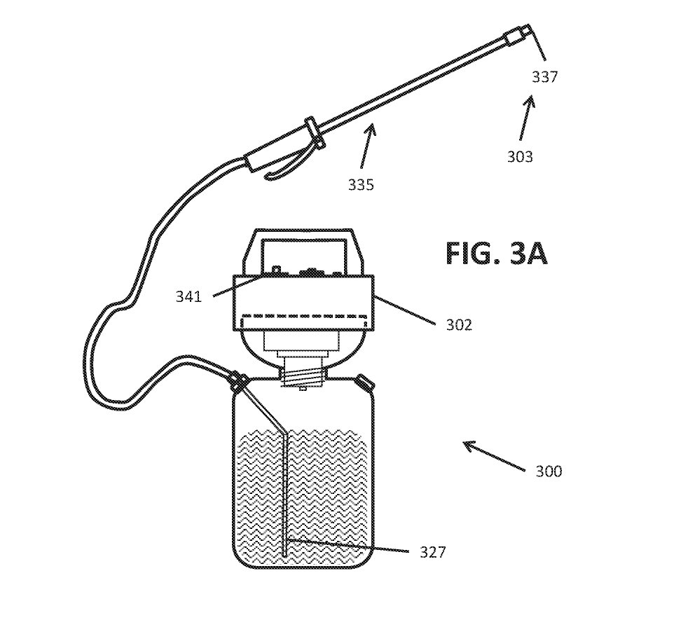

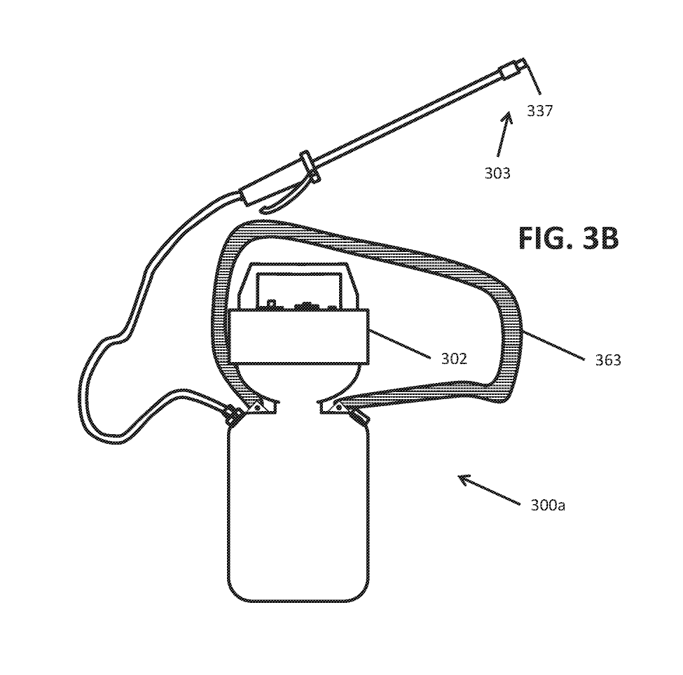

Another example of the invention is shown in FIG. 3A. In this example, the dispenser 300 is configured as a system that can be preferable for spraying water (or other liquid) drops instead of foam. In this example, the pump head 302 can be the same as the one shown in FIGS. 2A and 2D to 2F, and can replace the manual pump head that accompanies Model #90182. The system can then function as an ultra low pressure sprayer.

The inventors tried out a dispenser configured generally like dispenser 300a shown in FIG. 3A. The dip tube 327 had an ID of approximately 3 mm. The outlet assembly 303 had no mixing chamber but instead resembled an outlet assembly typical for most tank sprayers. The nozzle 337 used was a Tee Jet Nozzle, #8001 EVS. This is called an “Even Flat Spray Nozzle.” The resulting spray pattern appeared to be very even and had very few large- or uneven-size droplets, despite the fact that the pressurization system was producing pressure of only about 6 psi.

FIG. 3B shows another example, electric dispenser 300a. The only major difference from the dispenser 300 shown in FIG. 3A is the attached shoulder strap 363.

An electric dispenser prototype resembling dispenser 300a was used in the field to do herbicide spraying in November of 2015. The prototype incorporated all of the original parts of the Hudson Model #90182 including the dip tube and wand. The only alteration was that the manual pump was replaced with the electric pump head 302. Two different glyphosate herbicide solutions were used. The first tank solution contained approximately 10% Super Concentrate Killzall II Herbicide manufactured by Hi-Yield of Bonham, Tex., USA. (This herbicide has one or more surfactants and likely has anti-foaming agents included in the manufacturer's formulation.) The second spray solution contained approximately 8% Killzall Aquatic Herbicide, also from Hi Yield. This herbicide formulation contains no surfactant. Therefore, approximately 1% of a surfactant, Jarfactant™ 225DK, available from Jarchem Industries, Inc., of Newark, N.J., was added. This second spray solution contained no anti-foaming agent. Both solutions were at the maximum recommended label herbicide rate for foliar spot treatments. Both solutions included a marker colorant so that spray deposition could more easily be examined.

The blue nozzle tip that accompanied Model #90162 was used. (Although it had no markings, from a visual check, it appeared that the blue nozzle was a fan nozzle with an orifice size somewhat larger than the TeeJet® 8001 EVS. The knob was turned to approximately halfway, estimated to produce approximately 5 to 6 psi. The target weeds included Canada thistle (Cirsium arvense), bull thistle rosettes (Cirsium vulgare) and common mullein (Verbascum thapsus).

The coverage on the leaves of the weeds with the first spray solution was very even, and there was minimal beading on or dripping from the leaves. When the wand was passed once over a target plant, very distinct borders on the spray band could be observed. Coverage on lower leaves was good indicating that the spray could penetrate into the canopy of the weeds. The second spray solution with the added surfactant (and no anti-foaming agent) performed well. Foaming was minimal even though the mixture contained a surfactant and no anti-foaming agent. Coverage was still excellent.

What was also noteworthy in this field work was that in over two hours of spot spraying, the prototype electric dispenser maintained very constant pressures and consistent performance. The operator barely noticed engagement of the pump motor, suggesting that the electric pump easily handled the task of maintaining the appropriate pressure.

In another informal test under more controlled conditions indoors, the effects of tank pressure on spray drop quality was explored. To help understand this better, colored water was sprayed onto white paper at various pressure levels using the prototype electric dispenser resembling dispenser 300a. For comparison purposes, in some of the tests, the manual pump for the Hudson Model #90162 was used. The pressure relief valve on the tank was removed and a pressure gauge with a range of 0-30 psi was installed in opening.

An even flat fan nozzle from TeeJet was used: the TP8001 EVS. With different testing events, the tank was pressurized to 4, 6, 7, 8, 10, 15, 20, 25, and 30 psi. The manual pump was tested at each of these pressure levels. Because the electric pump of the prototype electric dispenser could produce a maximum of about 10 psi, the electric dispenser was only used at pressure levels up to 10 psi.

A 12 foot long sheet of white paper 18 inches wide was laid out on the floor. A wooden rail was suspended above the paper. With an operator resting the spray wand on the rail, the nozzle was suspended about 8 in. above the floor. The operator then walked along side the rail and sprayed the colored water on the paper. The colored drops formed a spray band with a length of about 10 feet on the paper.

At about 4 psi, drop quality appeared to be poor. However, with just a small increase in pressure—at about 5 to 8 psi—a spray band with evenly distributed, similarly sized medium-sized drops was achieved. From 9 to 15 psi, spray quality again appeared to deteriorate with 3 distinct heavier bands noticeable within the main spray band. At 20 psi, these bands largely disappeared and a pretty even distribution of drops occurred. However, the drops were quite fine.

It was noticed during these tests that large numbers of fine spray drops were deposited outside the main spray bands when operating at higher pressures. These drops were heaviest on the side opposite the operator. Therefore another test was conducted. In this test, a spray band was sprayed perpendicular to the longer dimension of a paper sheet 18 in. wide and over 60 in. long. The same rail and spray procedure mentioned above were used to make a spray band. This test was also conducted indoors. Two pressures were used: 7 psi (using the electric dispenser) and 30 psi (using the same dispenser with the manual pump). The purpose of this test was to examine drop distribution over a wider area outside the main spray bands.

At 30 psi, the main spray band was approximately 14 to 16 inches wide. However, small drops could be seen well outside the main band. In fact, on the side opposite the operator, small drops could still be detected 30 inches from the centerline of the spray band. Most of these drops were very fine, exactly the kind of drop that could easily drift outdoors.

On the other hand, with the electric dispenser 300a set at 7 psi the band was smaller with a total band width of about 8 to 10 inches. The drops sprayed at 7 psi were larger than those sprayed at 30 psi. On the side opposite the operator, no drops were observed beyond 14 inches from the centerline of the spray band. Moreover, the drops that did appear outside the main spray band were larger and thus of a size less likely to drift.

The results suggested with this informal test are surprising. The manufacturer of the 8001 EVS, TeeJet®, recommends using a minimum pressure of 20 psi. And indeed from about 9 psi to 20 psi, the quality of the spray band was not optimal. However, at ultra-low pressure between 5 and 8 psi, drop quality, consistency, and distribution were quite good. Therefore, ultra-low pressures can create high quality spray drops and spray patterns.

Just as important, when spray drops were produced within the manufacturer's recommended pressure range, e.g., at 30 psi using the manual pump, many more very fine drops were produced. Many of those fine drops landed well outside the main spray band. These fine drops are precisely the sort of drops that could land on non-target surfaces or that could easily drift. In contrast, when the electric dispenser was used to produce spray at ultra-low pressure of 7 psi, far fewer fine drops were observed outside the spray band.

This test suggests that the electric dispenser operating at ultra-low pressure is capable of producing high quality, well distributed drops, i.e., drops of similar sizes evenly distributed over the spray pattern) that are less likely to drift.

Another informal test explored the sensitivity of the control system in making small adjustments in pressure. (A prototype electric dispenser was again used.) This test was undertaken to help determine whether the control system had tight or sloppy operation. This inquiry was also undertaken to test the operator's subjective judgment during the field tests that the pump performed well at maintaining a nearly constant pressure and rarely ran for extended periods. For this test, an ultra-high accuracy pressure gauge was used, Ashcroft Type 1082, Grade 3A gauge with an accuracy of ±0.25 psi. The gauge had a range of 0 to 30 psi. 2 liters of water were added to a tank of a prototype dispenser resembling dispenser 300. A TeeJet® 8008EVS nozzle tip was installed on the spray wand. The power level was set to maximum pressure. The pump was turned on and allowed to run until it stopped. The nozzle was pointed into a container, and the wand lever was depressed. Water was sprayed until the pump started again. The original gauge reading and the reading at the point at which the pump started again were noted. This was done a total of 3 times. Then, the pump was shut off and the pressure released from the tank. The process was repeated two more times for a total of three rounds and a total of 9 “re-pressurization events.” On average, the maximum pressure achieved was between 10.1 and 10.2 psi. When spraying with the wand reduced pressure in the tank, it took only a drop of slightly more than 0.2 psi on average before the pump re-engaged to add pressure to the tank. This test thus suggests that pressure control was very tight and controlled it within a range of about 0.3 psi.

In a related test the sensitivity of the adjustment mechanism was explored. For this test, the same ultra-high accuracy pressure gauge was used. 2 liters of water were added to the tank of a prototype electric dispenser resembling dispenser 300. The knob (adjustment mechanism 341) was turned to the lowest setting. The prototype dispenser was turned on, and the pump was allowed to pressurize the tank. A reading was taken when the controller turned the pump off. Then, the knob was slowly turned until the pump engaged again. Another reading was taken after the pump stopped. This was repeated until the knob was turned as high as it could go. After the final reading was taken, the pump was turned off and the air released from the tank.

Three rounds of this test were done with the electric pump engaging 24, 25, and 27 times for an average including the initial pressurization of about 25 “pressurization events.” With the knob set at low, the pump pressurized the tank to an average of about 1.8 psi. With the knob set to high, the pump pressurized the tank to an average of 10.3 psi. This test indicates that quite fine adjustments in pressure could be made by turning the knob on the prototype dispenser.

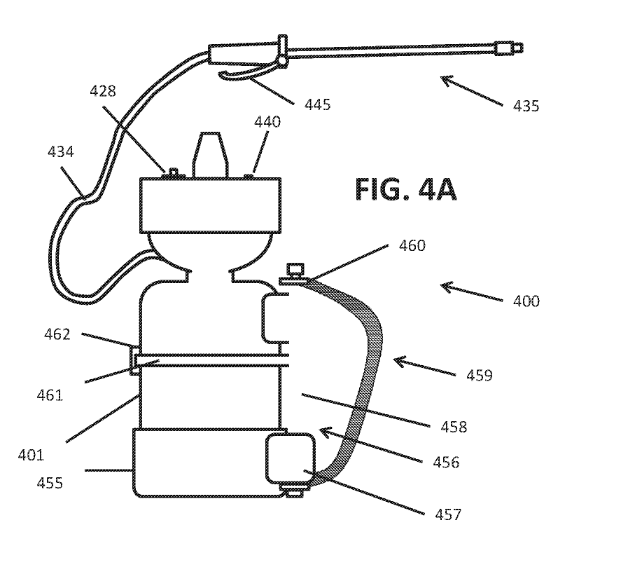

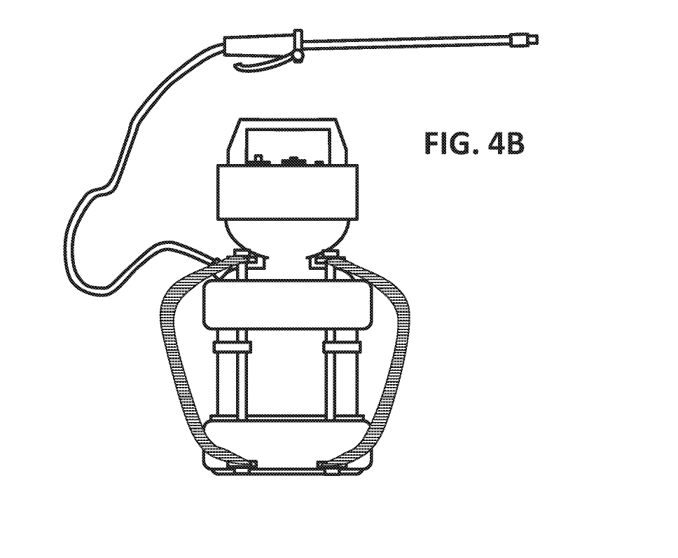

FIGS. 4A and 4B show another example of the invention. Here, the dispenser 400 is configured the same as dispenser 300 but with some differences. Dispenser 400 can be used with a backpack frame 456. The tank 401 can sit in a shallow pan 455 or other holder. The backpack can have a frame 456 that includes foam pads 457 and vertical support struts 458. In this example, the struts 458 pass through holes in the foam 457. Shoulder straps 459 can be attached to the struts 458. For instance, the struts 458 can pass through grommets 460 in the straps 459.

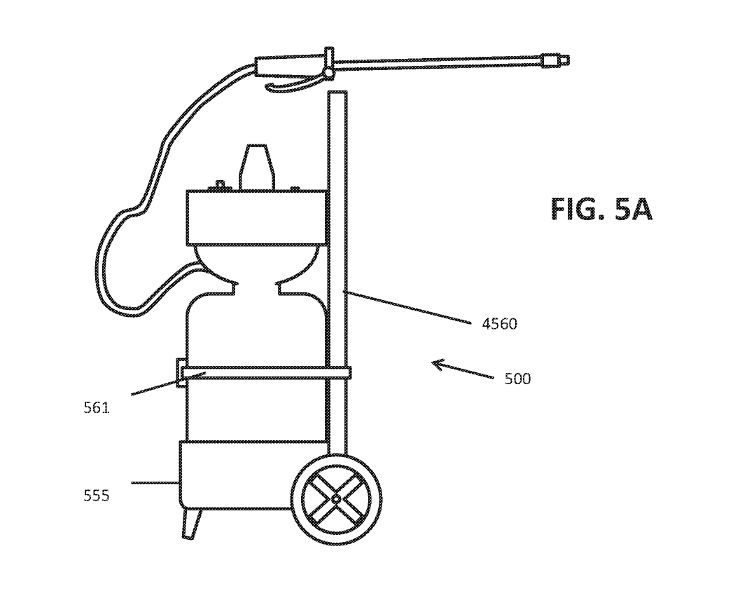

A cinching strap 461 can secure the tank to the frame 456. The cinching strap 461 can be tightened or loosened with a cinching mechanism 462 such as an over-center buckle. With the cinching strap 461 loosened, the tank 401 can be placed on the backpack frame 456 and rotated to different positions. This can allow the tank fitting (not shown) and hose 434 to be positioned in a position convenient for the operator (not shown). For example, the tank fitting 432 can be positioned on the right side as shown in FIG. 5B so the hose 434 is positioned on the right side for right-handed users or positioned (not shown) on the left side so the hose 434 is positioned on the left side for left-handed users. For people who like to switch hands, the tank fitting 432 and hose 434 can be positioned in the middle facing back (not shown), so the wand 435 could be held in either hand. In addition, the tank and wand can be removed from the frame 456 and can function as a pressurized tank sprayer.

The dispenser 400 can function well as a backpack dispenser. With the dispenser 400 on, the operator can control output of spray or foam by using the lever 445 on the wand 435. The operator can reach over a shoulder to the controls such as the on-off switch 440 or the adjustment knob 428. Unlike with the typical manually pumped backpack sprayer, there is no pump lever, therefore one hand is freed. Moreover, there is no pump lever to hit obstructions or catch on brush. Finally, the backpack harness, etc., can be less substantial than the ones typical to most backpack sprayers because there is no need for a firm base to press against when pumping manually.

FIG. 5A shows a dispenser 500 mounted on a cart 560. The dispenser 500 can sit in a shallow pan or other holder. A cinching strap 561 can hold the dispenser 500 in place.

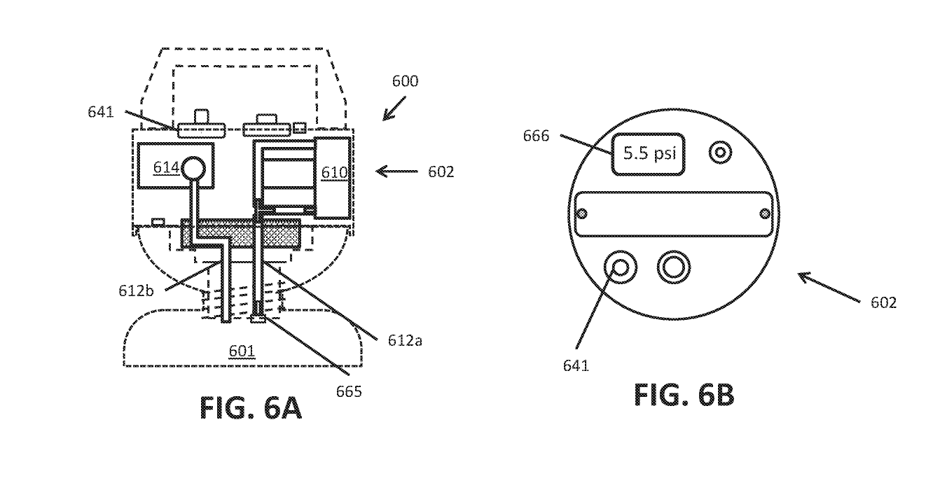

FIG. 6A shows the internal pump mechanism of a dispenser 600. The dispenser 600 can resemble those described in relation to FIGS. 1A to 5A but it can also have differences. With dispenser 600, the sensor for the controller 614 and pump 610 can have separate tubes 612a, 612b connecting them to the tank 601. The pressurized air tube 612a that transfers air from the pump 610 can have a check valve 665. The air tube 612b for the sensor for the controller 614 does not in this example. The check valve 665 can prevent backflow into the pump 610 if the dispenser 600 is tipped, etc. In addition, FIG. 6B shows the top face of the pump head 602. A readout 666 on the top face of the pump head 602—in this case a digital one—can indicate the pressure in the tank 601. The readout 666 can be helpful to the operator. For instance, when using a particular nozzle or application technique, the operator may want to use a particular pressure level and can set the adjustment knob 641 accordingly.

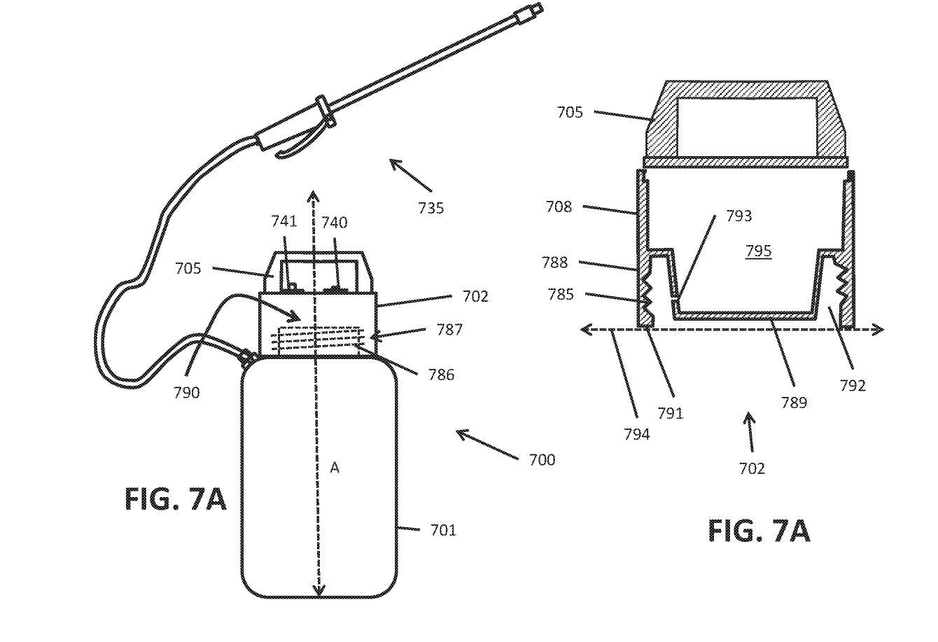

FIGS. 7A and 7B show an example of an electric dispenser, dispenser 700. The dispenser 700 can resemble those described in relation to FIGS. 1A to 6B. As with dispensers 100 to 600, dispenser 700 can have a pump head 702 that can function as a container for components of the pressurization system (not shown) and also can function as a reusable closure for the supply tank 701. (The term “reusable closure” can distinguish the closure from a “single use closure.”) However, there can be some differences. The pump head 702 can a closure system with female threads 785 unlike, for example, pump head 302 which has male threads on the plug 221. The female threads 785 can seal with the male threads 786 on the finish 787 of the supply tank. Thus, the pump head 702 can form a seal with the supply tank 701 and can function as a reusable cap closure (i.e., an “external closure” as opposed to, e.g., the internal closure provided by the threaded male plug 221 of dispenser 200).

The pump head 702 can be cylindrical and can share a vertical axis (identified dashed line “A”) with the cylindrically-shaped supply tank 701. The upper part of the reusable closure or pump head 702 can enclose the container for the electronic components 795 (not separately shown) The lower part of the cylindrical wall of the pump head can form the skirt 788 that surrounds the finish 787 when the pump head seals the supply tank 701.

The pump head 702 can have a belly 789 within the cap interior 792 that hangs in the fill opening 790 when the pump head is screwed onto the supply tank 701. The belly 789, however, can be constructed such that the belly 789 does not hang below the bottom rim 791 of the skirt 788. Thus when the pump head 702 is removed from the supply tank 701, it can be placed on a surface 794 without contaminating surfaces of the cap interior 792.

This contrasts with conventional tank sprayers with manual pumps, which typically have a pump cylinder that projects down into the interior of the supply tank. When the pump is removed from a conventional tank sprayer filled with liquid, the pump cylinder will have beads of the liquid on its outer surface. The operator cannot lay the conventional pump on a surface without contaminating the pump cylinder or the surface on which it is laid. This makes refilling a conventional tank sprayer especially inconvenient in the field.

Another difference with dispenser 700 can be the position of the exit 793 for the air supply from the pump (not shown) to pressurize the supply tank 701. In this example, the exit 793 can be located on the vertically oriented wall of the belly 789. This location can be advantageous because it can be more protected from the contents of the supply tank 701.

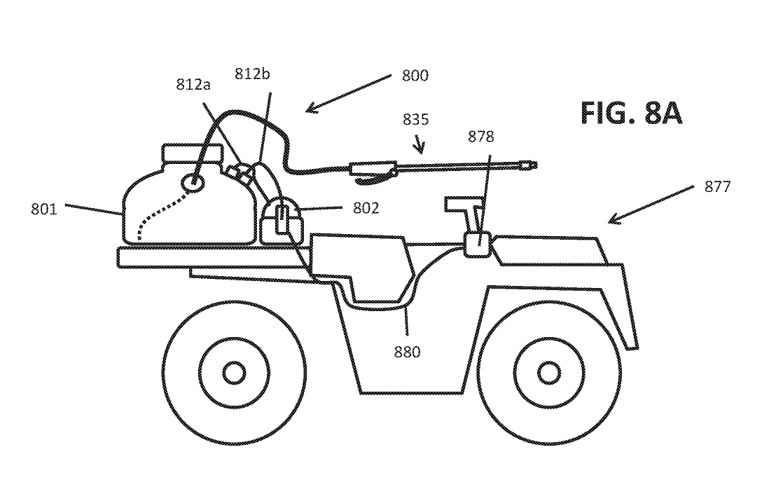

FIG. 8A shows a dispenser 800. The dispenser 800 can resemble those described in relation to FIGS. 1A to 7B, but it can also have differences. The dispenser 800 can be mounted on a vehicle 877. The pump head 802 can be a separate unit connected to a supply tank 801 by an air tube 812a for the pump contained by the pump head 802 and a sampling tube 812b for the sensor system (part of the sensor system can be located in enclosure associated with the control panel 878). The supply tank 801 can be significantly larger than one carried by a human—for example, for use on an all-terrain-vehicle, the supply tank can preferably have a capacity of between 3 and 30 gallons.

The air pump can be significantly larger in size which means it can readily be configured to generate more air flow, generate higher pressure, or both if desired. For example, the pump could be preferably be configured to produce pressures in the pressurizable space of between 1.5 psi and 30 psi. (Of course, still higher pressures could be achieved if necessary. If so, more robust components such as a metal supply tank and reinforced hoses can be used.)

To accommodate the larger air pump, other changes can be made: as examples, a larger power source can be installed (or the system can use of electric current generated by the vehicle); a sensor (or multiple sensors) can be utilized to sense a wider range of pressures; and the size of the pump head 802 housing can be increased to accommodate the larger components.

In addition, the pressurization system can be configured with electronic pressure relief. The electronic pressure relief can be performed with an air pump that can reverse flow. Alternatively, in another embodiment, the pressurization system can rely on an electronically activated pressure relief valve (not shown). The electronic pressure relief can depressurize the pressurizable space if the pressure level exceeds a desired pressure level. This feature might be especially useful for a dispenser 800 that can operate at higher pressure. For example, the operator may have set the desired pressure level at 30 psi and allowed the dispenser to be pressurized to that pressure level. However, the operator may determine that the pressure being used is too high for a given application. Then, the operator could use an adjustment mechanism to adjust the desired pressure level down, to say 10 psi. Instead of having to use the wand 835 to spray and reduce pressure (or to release pressure using a manual pressure relief valve (not shown)), the system could automatically release excess pressure and stop the release when the new desired pressure level of 10 psi is reached. In addition, the controller could be programmed to release all pressure from the pressurizable space anytime the switch is turned off (or the dispenser is not used for an extended period of time).

In addition, the air pump for dispenser 800 can incorporate a feature such as variable speed. At high speed the pump can move more gas into the pressurizable space. At low speed the pump can pump less gas but can do so against higher pressure levels in the pressurizable space. This can allow the rate of pressurization of the pressurizable space to be increased when, for example, pressure levels are low in that space. Then, when the pressure levels are high in the pressurizable space, pressurization can be automatically slowed to ensure full pressurization.

Still another difference shown in FIG. 8A can be the remote control panel 878. The control panel 878 can include, for example, an on-off switch and an adjustment knob (not shown). The control panel enclosure can contain portions of the electronics for the pressurization system. An electric cable 880 can link the control panel 878 to the pump head 802. The control panel 878 can be linked to the pump head in other ways, e.g., wirelessly.

The electric dispenser described in relation to FIGS. 1A to 8A can have a number of advantages over prior art ones. First, it can operate at ultra-low pressure, e.g., pressure below 10 psi. At these low pressures, the electric dispenser can produce a pattern of high quality, well distributed liquid spray drops. High quality can mean that the drops are not too big or too small. Well distributed drops can mean that drops of a certain size are not concentrated in any part of the spray pattern but are distributed evenly throughout the pattern. Drops produced at ultra-low pressure can have other advantages. Research indicates spray drops ejected from a nozzle at lower pressure have lower velocity. Drops having lower velocity break apart less as they leave the nozzle resulting in fewer fine drops. Fine drops can be problematic because they can easily drift or can dry too quickly when they hit the target (Dried systemic herbicide drops, for example, can crystallize and fall off leaves or may not be absorbed into the weed's vascular system.) Drops having lower velocity also tend to stay on leaves or foliage as opposed to high velocity drops which may bounce or glance off targets such as leaves. The informal tests conducted with a prototype electric dispenser indicated that the spray drops applied using the electric dispenser were retained well by plant foliage. Problems such as excessive dripping, beading, patchy coverage; or poor canopy penetration were not observed. The informal spray droplet tests indicated that the ultra-low pressure spray from the electric dispenser formed fewer fine droplets of a kind that can readily move outside the spray pattern.

Additionally, ultra-low pressure—even pressure levels below 2 psi can be useful for some spray treatments where a very slow and narrow spray stream is desirable. For example, when herbicide dispensers are used for basal bark treatments on trees, a lower portion of the trunk of the tree is sprayed with a ester herbicide that can soak through the bark. In this situations, herbicide sprayed at higher pressures and with greater flow using sprayers presently available on the market can be very wasteful. The broader spray pattern can miss the target stem, especially when the stem is a small one, e.g., under 2 inches. In addition, the spray can rapidly flow down the trunk onto the ground. This is wasteful and environmentally harmful. The electric sprayer can be configured to spray at pressure levels below 2 psi and even below 1 psi. Especially for basally treating small stems, these low pressure levels can be useful.

Second, an electric dispenser that operates at ultra-low pressure has other significant advantages. The electric dispenser can demand less power from the pressurization system and require less material strength for the dispenser components. This means the electric dispenser system can be lighter, less bulky, and less expensive to produce, and, if the dispenser is battery-powered, the dispenser can operate longer on a charge than conventional electric dispensers. The pump can also be a high volume, low pressure one which means the tank can be filled with air faster, and the pump itself can be a more economical one. In addition, extra components such as mechanical pressure relief valves can be unnecessary. The control system of the electric dispenser can limit the maximum pressure.

Third, pressure levels for the electric dispenser can be finely tuned to the desired pressure. Tests suggested the control system could maintain the pressure level when the pressure dropped by an average of approximately 0.2 psi. This consistency in pressure is important for the delivery of consistent spray drops.

It avoids, for example, the pressure fluctuations of conventional, manually pumped backpack sprayers and also avoids the steady pressure drop of manually pumped tank sprayers. The tight control can avoid the problem that sloppy control causes in a control system's feedback loop. It can mean that the power system is taxed less when trying to re-pressurize a tank during usage.

Fourth, the electric dispenser can allow for very tight controls on the amount of pressure used by an operator and minimize the potential for human error. For example, in the typical herbicide spraying context, the operator has a great deal of control over the amount of pressure used. This can be problematic. An unskilled or careless operator using prior art, high pressure spray systems can readily use excessive pressure. This can lead to excessive drift, especially because the creation of fine, drift-prone drops during a spraying operation may not be readily noticed by the operator because they can be hard to see.

Fifth, the electric dispenser can be highly versatile. In several examples above, the pump head contains the primary components of the pressurization system and could be used with a variety of pressurized fluid storage and output systems, including ones that are presently on the market. For example, a pump head according to the present invention designed for use with a pressurized tank sprayer and wand could be used with a variety of conventional tank sprayer systems currently on the market.

The user would only be required to unscrew the manual pump (which is done with each filling of the tank) and replace it with the electric pump head of the present invention. No other adaptation would be necessary. In addition, the pump head could be used with backpack systems; it could be readily incorporated into systems on carts or motorized vehicles.

Sixth, containing the pressurization system in the pump head as is done with several of the examples can have other advantages. It places the electronic components well above the liquid; therefore if leakage occurs, the electronic components are less likely to be harmed. Because the pump head can use the same orifice as is used for filling on a standard pressurized tank system, the number of orifices overall on the tank can be reduced. This minimizes the risk of leakage and is more economical. The high placement of the pump system also allows the tank to be filled to a higher level without risking backflow into the tubes connected to the electric pump or sensor.

Seventh, the electric dispenser can have a number of advantages over systems that use liquid pumps. Only air need pass through the pump of the examples above. This can reduce wear (especially if aggressive chemicals are dispensed), clogging, etc. A more consistent operating pressure can be maintained. A wider variety of liquids can be dispensed—ones with higher viscosity, more aggressive ones, abrasive suspensions, etc.

Eighth, the electric dispenser can function very well as a foam dispenser with a few changes in the componentry. Low pressure can produce high quality foam. High pressure can readily burst or shear bubbles in the foam as it exits a nozzle creating fine spray particles with the same drift problems associated with high pressure spray systems. Moreover, very high quality foam can be produced at pressure below 10 psi and even 5 psi. The electric dispenser can readily achieve these low pressures. The low pressures produced by the electric dispenser can be especially useful for the precise placement of foam onto surfaces, using for example wiping or dabbing techniques. Just as importantly, precise and constant low pressure levels can be maintained for long periods of time. Therefore, the dispensing operation does not have to be constantly interrupted with manual pump strokes necessary to maintain the appropriate pressure. At slightly higher pressures, e.g., preferably above 5 psi, and with the appropriate nozzle, foam streams could easily be projected over ten feet. Such foam streams can be used for foliar application operations.

Many other embodiments could be configured differently than as described above. The dispenser can be larger or smaller; carried by a person or animal with or without handles, straps, and so forth; it can be carried on wheels, skids, etc., on or in a vehicle such as a cart, trailer, motor vehicle, boat, robot, airplane, drone etc. different versions could be mounted on a wall or a countertop; a dashboard, and so forth. Several of the examples shown above show the components of the system contained within a pump head. However, the components can be configured in other ways too. In most of the examples above, the pump head housing also acts a removable closure for the fill opening of the supply tank. A dispenser can be made that has a conventional closure for the fill opening and the pump head can be independently mounted on the tank or remotely mounted. It can be configured so that its various components are in one or more remote units. For example, one or more parts of the control unit could be located remotely and connected with wire or wirelessly to the remaining components. Similarly, hoses or lines can connect one or more tanks, one or more pump heads and one or more outlet assemblies remote units. For example, the device could be a tank with an attached pump head connected to a hose with a wand at the distal end having an outlet assembly. The device could have one or more tanks; one or more pump heads, or one or more outlet assemblies. A common configuration might be to have one tank and pump head with multiple outlet assemblies or nozzles. Many of the devices described above operate with low pressure or ultra-low pressure. However, these systems could be readily adapted to be higher pressure systems. For example, with different batteries, motors, and transducers, higher pressures could readily be attainable, even in a dispenser carried by a human.

The electronics of the pressurization system can be configured differently than the ones described above. For example, a conventional pressure switch can be used to activate the pressurization system.

The above-discussed embodiments of the present invention generally relate to a dispenser for dispensing a liquid or foam. The invention should be understood to encompass these other uses although such other uses may not have been discussed.

The invention has been described with reference to various and specific non-limiting embodiments, examples and techniques. One of ordinary skill in the art will understand that reasonable variations and modifications may be made with respect to such embodiments and techniques without substantial departure from either the spirit or scope of the invention defined in the claims. For example, while suitable sizes and parameters, materials, and the like have been disclosed in the above discussion, it should be appreciated that these are provided by way of example and not of limitation as a number of other sizes and parameters, materials.

What is claimed is:

1. An electric dispenser, comprising:
a pressurization system for automatically regulating a pressure level of a gas in a pressurizable space,
the pressurization system being configured: to take a pressure reading of the gas, to make a determination if the pressure reading indicates a deviation from a desired pressure level, and based on the determination to make a decision selected from a list comprising at least the following: to start pressurization, to continue pressurization, to stop pressurization, or to do nothing.

2. The dispenser of claim 1, wherein the pressurization system is sufficiently sensitive to indicate the deviation even if the deviation is minimal, between 0.1 and 1.0 psi.

3. The dispenser of claim 1, wherein the pressurization system is sufficiently sensitive to indicate the deviation even if the deviation is minimal, between 0.1 and 0.5 psi.

4. The dispenser of claim 1, wherein the pressurization system is sufficiently sensitive to indicate the deviation even if the deviation is minimal, between 0.1 and 0.3 psi.

5. The dispenser of claim 1, wherein the desired pressure level is less than 20 psi.

6. The dispenser of claim 1, wherein the desired pressure level is less than 10 psi.

7. The dispenser of claim 1, wherein the desired pressure level is less than 8 psi.

8. The dispenser of claim 1, wherein the desired pressure level is selectable from at least 2 selectable pressure levels.

9. The dispenser of claim 1, wherein the desired pressure level is selectable from at least 20 selectable pressure levels.

10. The dispenser of claim 1, wherein the desired pressure level is selectable by an operator using a manual adjustment mechanism.

11. The dispenser of claim 1, wherein the desired pressure level is selectable from at least 2 selectable pressure levels, and at least one of those selectable pressure levels is less than 10 psi.

12. The dispenser of claim 1, wherein the list further comprises the decision to depressurize.

13. The dispenser of claim 1, wherein the list further comprises the decision to increase the rate of pressurization if the determination is that the pressure reading is below the desired pressure level and the deviation is significant.

14. The dispenser of claim 13, wherein a significant deviation is a deviation of 2 psi or greater.

15. The dispenser of claim 1, wherein the dispenser further comprises an outlet assembly for ejecting spray drops.

16. The dispenser of claim 1, wherein at least a portion of the pressurizable space is located in a headspace in a supply tank.

17. An electric dispenser, comprising: a pressurization system for automatically regulating pressure in a pressurizable space, the pressurization system being configured to regulate pressure in the pressurizable space to seek a desired pressure level, wherein the desired pressure level is 12 psi or less.

18. The dispenser of claim 17, wherein the desired pressure level is 8 psi or less.

19. The dispenser of claim 17, wherein the desired pressure level is 5 psi or less.

20. An electrically powered dispenser, comprising:
a supply tank, the supply tank further comprising a top with an opening for filling the supply tank;
A reusable closure for sealing the opening;
A pressurizable space created when the reusable closure seals the opening; and,
wherein the closure contains a pressurization system for automatically regulating a pressure level to seek a desired pressure level in the pressurizable space.
